(19) United States
(12) Patent Application Publication
(10) Pub. No.: US 2023/0353423 A1
(43) Pub. Date: Nov. 2, 2023

(54) HYBRID PROXY ANONYMITY SYSTEM USING DISTRIBUTED PROTOCOL TO SIMULTANEOUSLY DISSEMINATE REQUESTS AND RETURN DATA ACROSS SEVERAL IP ADDRESSES

(71) Applicants: AI BOT FACTORY LLC, Greenville, SC (US); SKELETON KEY PROXY LLC, Greenville, SC (US)

(72) Inventor: Stephen N. Brown, Greenville, SC (US)

(73) Assignees: AI Bot Factory LLC, Greenville, SC (US); Skeleton Key Proxy LLC, Greenville, SC (US)

(21) Appl. No.: 18/026,303

(22) PCT Filed: Aug. 17, 2021
(86) PCT No.: PCT/US2021/046320

§ 371 Date: Mar. 14, 2023

Related U.S. Application Data
(60) Provisional application No. 63/084,678, filed on Sep. 29, 2020.

(51) Int. Cl. H04L 12/46; H04L 9/40

(52) U.S. Cl. CPC H04L 12/4633; H04L 63/0421; H04L 12/4641

(57) ABSTRACT

A system and process anonymize a user identity, location, and information on the Internet by fragmenting a user request for information from a targeted site, or delivery of user information thereto, into multiple, separate requests/deliveries that are each routed through unrelated, random remote computers or nodes. The fragmented requests each gather or send a piece of information from or to the target site, and bits of information are returned through yet other random nodes. Through this disintegrated approach, the location and identity of the user and the content of the information are untraceable.

### CROSS-REFERENCE TO RELATED APPLICATIONS

This utility patent application claims priority to international patent application number PCT/US21/46320 filed in the United States Patent and Trademark Office (“USPTO”) as the Receiving Office on Aug. 17, 2021, which claims benefit of U.S. Provisional Patent Application Ser. No. 63/084,678 filed in the USPTO on Sep. 29, 2021, both of which are incorporated herein by reference thereto.

### BACKGROUND OF THE DISCLOSURE

For reasons ranging from personal to political, countless Internet users want and need to remain anonymous when searching for information or posting content on the World Wide Web. Achieving and maintaining true anonymity, however, has been an elusive objective since the inception of the Internet. Various methods and approaches for preserving anonymity have been developed, but they are not foolproof. Given sufficient resources, user identity is susceptible to tracing and discovery by corporations, governments, and malicious eavesdroppers.

A virtual private network (VPN), for instance, is a well-known method of encrypting a connection over the internet to privately transmit data. VPNs are intended to allow a user to work remotely and to prevent unauthorized people from eavesdropping on data transmitted to and from the user. However, the identity and location of the user employing known VPN technology, although perhaps difficult, is not untraceable.

Still further, proxy servers, proxy rotators, tunnel systems, and the like have been employed with varying degrees of success in attempts to obscure data content between a local computer and a server. But these techniques do not fully conceal the user's identity, location, and data content. Ultimately, all of these identifiers can be traced and decrypted. Although only minor humiliation might be the consequence to a user discovered in most geographic areas or situations, a discovered user might be physically harmed or imprisoned under certain authoritarian regimes that severely restrict personal freedoms. So, Internet anonymity can be a lifesaver rather than a simple luxury.

What is needed in the cyberspace industry is a system for truly anonymizing the identities of users and concealing their data sources and destinations.

### BRIEF SUMMARY OF THE DISCLOSURE

The present disclosure is directed in general to a system that genuinely anonymizes an Internet user by fragmenting a user request, or information sent by the user, into a multitude of separate information packets that are each routed through unrelated remote computers/servers or “nodes” to a targeted site or receiver. The systems and methods herein may be described broadly as a “Hive Anonymity System” (HAS). For instance, fragmented or chunked requests routed through various random nodes each gather a piece of information from a target site, and each bit of information is returned through another random node. Through this disintegrated approach, it appears to the targeted site that numerous disparate requests are arriving from unrelated requestors, and the apparently unrelated pieces of information may be routed through yet another random set of nodes to the original user. Accordingly, the location and identity of the user and the content of the requested or received information are unrelatable and untraceable.

More generally, the present disclosure offers a unique VPN (known as “Beanstalk”) and a VPN/Proxy Hybrid proxy or HAS, which may include a “Branch” a “Stem” and a “Leaf” that together may be referred to as an “r2b server fabric.” The Beanstalk and the HAS are also known as the Skeleton Key Proxy™ system, which not only moves data but includes packet blending and packet re-writing or branching from a user's private relay access point into the r2b server fabric.

In one embodiment according to the disclosure, a hive anonymity system may include a Branch node, a Stem node, a Leaf node, and a Bridge node, wherein the Branch node includes a connection to a client or to a load balancer, wherein the Stem node is a point to which the Leaf node connects, wherein the Leaf node is one or more random, geographically distributed affiliate points being configured to request a payload to process from the Bridge node, and wherein the Bridge node is a nominal server. In the hive anonymity system of the foregoing embodiment, a user may connect to the Bridge node via an internet capable device. The system may then create a packet tunneling protocol to connect a user anonymously to an external resource.

In another embodiment according to the disclosure, a Hybrid Wide Area Network Inter Process Communication system using a type of doubly linked list may include: forming a core comprising a Branch Node and a Stem Node; receiving a request from a client; creating a socket connection to the Branch Node; creating a thread and link in the doubly linked list by the Branch Node; connecting the Stem Node and the Branch Node by an internal IPC; searching the list by the Stem Node, wherein the Stem Node uses an SLT over an IPC in cooperation with the Branch Node to find an available job and returns the job to the Leaf Node; attaching a thread/process to a pointer of an IPC memory segment holding the link in the list; and establishing a memory pipe between the Client, the Branch Node, the Stem Node, and the Leaf Node.

The Hybrid Wide Area Network Inter Process Communication system in this embodiment may further include: when the Leaf Node returns data, writing to a socket that is connected to the Stem Node.

Still further, the Hybrid Wide Area Network Inter Process Communication system may include: reading the payload by the Stem node and writing to the IPC memory segment that contains a socket directly connected to the Client and/or responding by the Client over the socket that is connected to the Branch Node and/or: writing, by the Branch Node, to the IPC with the Stem Node that contains a socket connected to the Leaf Node and/or: reading, by the Leaf Node, a response until connection is terminated. In a further embodiment, a Simi-Lockless Triplet is provided that may include: locking only a minimum number of links in a doubly linked list and/or: adding an item at a head of the list by proving each required link with a locking request and acquiring a lock thereon; pushing a second link into a memory structure of the list by pointing to an address of a third link; updating a pointer of the second link to the initial link in the list; and updating the initial link with the address of the second link, and/or: reversing order to add an item at the end of the list.

Still further, the Simi-Lockless Triplet in this embodiment may include removing an item from any point except the beginning or end by proving each required link with a locking request; acquiring a first removal link to be removed; acquired a lock on a second link prior to the first removal link; acquiring a lock on a third link following the first removal link; updating a pointer of the first removal link no longer point to the third link; updating the third link pointer to the first removal link; releasing locks on the third link pointer and the first removal link; and deleting the second link.

In yet another embodiment, an artificial intelligent system may include a neural network trained to route a user request from an r2b server to a resource via a plurality of external IP addresses, wherein the request is fragmented into a plurality of sub-requests as perceived by the resource, each sub-request receiving a discrete pipe for sending and receiving data to and from the user. The artificial intelligent system may include returning the data to the user via another set of IP addresses.

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode thereof directed to one of ordinary skill in the art, is set forth in the specification, which refers to the appended figures, wherein:

FIG. 1 is a schematic view of an embodiment of a Hive Anonymity System according to the disclosure showing how a user connects to the system and an associated logic flow for fetching resources;

FIG. 2 is a more detailed schematic view of the system as in FIG. 1, particularly showing how requests are processed between system components and a requested resource;

FIG. 3 is a schematic view of a flow within a data center according to an aspect of the disclosure, particularly showing an R2B Stem Node Request being processed without CDIPC fulfillment; and

FIG. 4 shows a multi-DC-DB.

### DETAILED DESCRIPTION OF THE DISCLOSURE

As required, detailed embodiments are disclosed herein; however, the disclosed embodiments are merely exemplary and may be embodied in various forms. Therefore, specific structural and functional details disclosed herein are not to be interpreted as limiting, but merely as a basis for the claims and as a representative basis for teaching one skilled in the art to variously employ the exemplary embodiments of the present disclosure, as well as their equivalents.

Unless defined otherwise, all technical and scientific terms used herein have the same meaning as is commonly understood by one of ordinary skill in the art to which this disclosure belongs. In the event that there is a plurality of definitions for a term or acronym herein, those in this section prevail unless stated otherwise.

Skeleton Key Proxy™ (“SKP™”), as briefly introduced, includes the VPN (“Beanstalk”) and the VPN/Proxy Hybrid (“Branch” and “Stem” and “Leaf” that make up the “r2b server fabric” or “HAS Fabric”) for moving the data.

“HAS” means Hive Anonymity® System or Hive Anonymity® services according to context.

“HAS Fabric” refers to the r2b server fabric or the HAS innerworkings, optionally including a Client, a Bridge Node, a Branch Node, a Stem Node, and a Leaf Node.

“HAS Client” is a HAS Local Client utilized by a user to send and receive data with more configuration options and optimized performance.

“Beanstalk” is a one-to-one (1-to-1) connection pipe originating from a user location to servers to the user target or destination wherein all requests appear to originate from the SKP™ system or server. Beanstalk does not use standard VPN protocols but employs its own protocol such that Beanstalk appears as standard web traffic rather than emitting a conventional VPN signature.

“Branch” is the point at which the user connects, which may be a direct connection to a “node” or via an SKP™ load balancer.

CDIPC means Commodious Disjointed Inter Process Communication. CDIPC is not a standard Wide Area Network Inter Process Communication (WANIPC) but a process in which normally disconnected networks become connected over a wide area or expansive set of regions and or localities.

Internet Capable Device means including but not limited to Portable, Non-Portable, Wearable, Non-Wearable, Embedded, Non-Embedded, Automated, Human Controlled devices or software and combinations thereof, capable of using a proxy or the HAS local client.

“Leaf nodes” (or “nodes” or “Leaf” or “Local Client”) are individual points running from discrete locations around the world. Leaf nodes request a payload or data to process from “Stem” servers, and after fetching the payload, the Leaf returns the data to the Stem server.

“Stem” is a point to which a Leaf node connects. Stem servers may delegate requests to Leaf nodes, even if a node on which a Stem server is running is not processing a request (requiring a Branch plus shared memory with a Stem to which the request is connected). Stem servers can delegate requests from any Branch server because all r2b servers are connected to a form akin to a neural network. R2b servers know of all requests from all other r2b servers. This includes the information needed to establish a direct memory pipe between the Branch+Stem+Leaf. If the Branch+Stem server is not the originator of the request, the Leaf node will begin processing the request that it received from requesting Stem server. Before returning data, the Leaf will connect to the proper Stem server that has the open connection back to the user for this request. Upon the start of the data transfer from the Leaf node, the Stem server then attaches to the memory of the Branch server that has the open connection and establishes a system (kernel level pipe and user space) directly bridging all parties for this particular transfer.

“Bridge” is a simplified server by which a user may obtain an application to host an individual private access point to facilitate an alternative access to the HAS Fabric, for instance, in a country which has blocked HAS servers.

“IPC” is Inter Process Communication or an Inter Process Communicator.

“Latency” (or Lag) is a time delay between a cause and an effect of some physical change in the system being observed, but as used herein “latency” is a time interval between the input to a stimulation and the visual or auditory response, often occurring because of network delay.

“DC” means data center.

“Multihoming” means the practice of connecting a host or a computer network to more than one network to increase reliability or performance.

“WANIPC” is Wide Area Network Inter Process Communication.

“R2B” is Routing Request Branching Server Node.

“SLT” is a Simi-Lockless Triplet™.

“Packet” is a Formatted Unit of Data.

“Frame” is a container for a single Packet pursuant to an OSI (Open Systems Interconnection) model.

Sub-requests mean subsidiary or “child” requests that build a primary or “parent” request. For instance, when establishing a TLS connection, a Leaf node will process all requests to finish building the parent request. Under other contexts, such as building and rendering a web page, many requests can be processed by multiple Leaf nodes. So, the context of sub-requests will depend upon the overarching parent request.

“TLS Connection” is a comprehensive Transport Layer Security handshake to establish a master password according to the present disclosure.

“TLS Session” uses an existing TLS Connection.

“User” or “User Device” means any portable, non-portable, wearable, non-wearable, embedded, non-embedded, automated, human controlled device, or software that can access the Internet.

The phrase “Artificial Intelligence” (AI) means a synthetic entity that can make decisions, solve problems, and function like a human being by learning from examples and experience, understanding human language, and/or interactions with a human user, i.e., via a chat system. The AI synthetic entity may be equipped with memory and a processor having a neural network, as well as other components, that can iteratively learn via supervised machine learning (ML) (for example, through inputted data) or capable of autonomous, unsupervised deep learning (DL) (for example, based on inputted data or perceived data and trial and error). AI, ML, and DL may be used interchangeably herein.

A neural network as used herein means AI having an input level or data entry layer, a processing level (which includes at least one algorithm to receive and interpret data but generally at least two algorithms that process data by assigning significances, biases, et cetera to the data and interact with each other to refine conclusion or results), and an output layer or results level that produces conclusions or results.

Wherever the phrases “for example,” “such as,” “including,” and the like are used herein, the phrase “and without limitation” is understood to follow unless explicitly stated otherwise. Similarly, “an example,” “exemplary,” and the like are understood to be non-limiting.

The term “substantially” allows for deviations from the descriptor that do not negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

Unless the context clearly requires otherwise, throughout the description and the claims, the words “comprise”, “comprising”, and the like are to be construed in an inclusive sense as opposed to an exclusive or exhaustive sense; in the sense of “including, but not limited to.”

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, et cetera. Thus, for example, “a device having components a, b, and c” means that the device includes at least components a, b, and c. Similarly, the phrase: “a method involving steps a, b, and c” means that the method includes at least steps a, b, and c.

Where a list of alternative component terms is used, e.g., “a structure such as ‘a’, ‘c’, ‘d’ or the like”, or “a” or b”, such lists and alternative terms provide meaning and context for the sake of illustration, unless indicated otherwise. Also, relative terms such as “first,” “second,” “third,” “front,” and “rear” are intended to identify or distinguish one component or feature from another similar component or feature, unless indicated otherwise herein.

The various embodiments of the disclosure and/or equivalents falling within the scope of the present disclosure overcome or ameliorate at least one of the disadvantages of the prior art.

Detailed reference will now be made to the drawings in which examples embodying the present subject matter are shown. The detailed description uses numerical and letter designations to refer to features of the drawings. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. The drawings are not necessarily to scale, and some features may be exaggerated to show details of particular components. Thus, the examples set forth in the drawings and detailed descriptions are provided by way of explanation only and are not meant as limitations of the disclosure. The present subject matter thus includes any modifications and variations of the following examples as come within the scope of the appended claims and their equivalents.

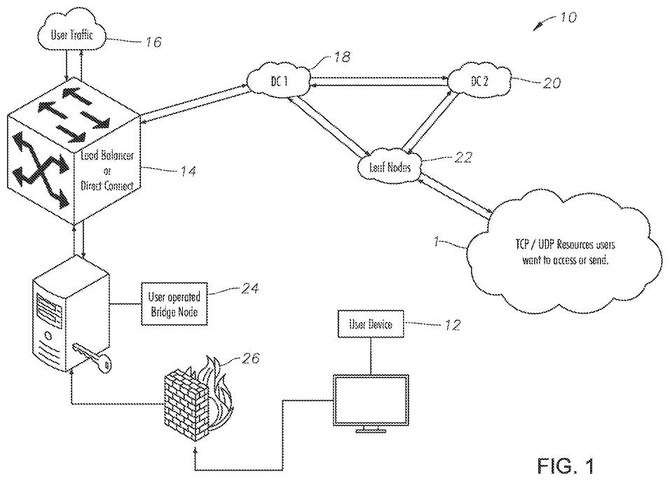

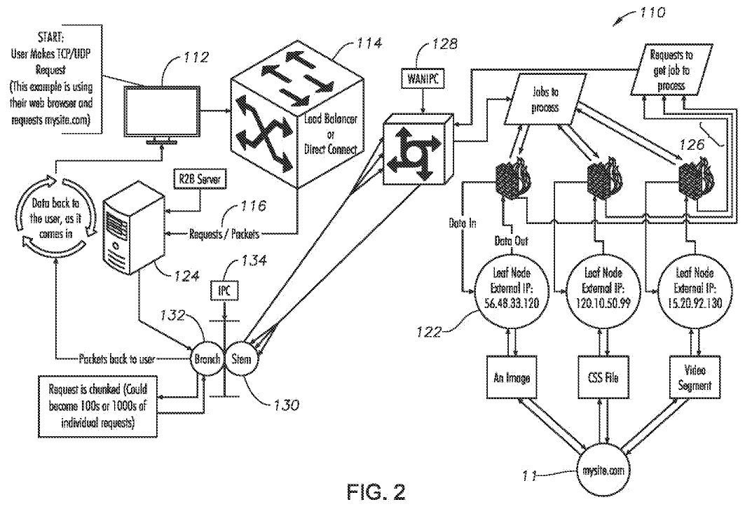

Turning now to FIG. 1, an exemplary, high-level HAS Fabric is designated broadly by the element number 10. The HAS Fabric 10 includes methods of connecting to the HAS network and basic logic flow for fetching resources 1. As shown, users or user devices 12 may directly connect to an R2B server or to a HAS load balancer 14. In this example a user request 16 (also known as jobs or traffic) for resources 1 is processed by a data center “DC 1” 18. The resource request 16 and its sub-requests that make up the parent requests are synced between DC 1 18 and another data center “DC 2” 20. These are discussed in further detail with respect to the Stem Node below. If the user 12 has locked the request processing to a specific region, only Leaf Nodes 22 within the specified region(s) may process the jobs 16. Otherwise, any Leaf Node 22 may process the jobs 16. The Leaf Nodes 22 receive or send the requested resource 1 via a WANIPC, all of which are described in greater detail with respect to FIG. 2 below.

FIG. 1 further shows that users 12 can also use a HAS-provided Bridge Node or Bridge 24 or another of their choosing. The Bridge 24 facilitates HAS access when the user 12 is not able to access the well-known DNS and IP addresses, such as from within a country censoring this service. The Bridge 24 is provided by the user 12 and is not operated by SKP™ or the HAS network 10. Here, the contents 16 will be encrypted or masked, and the Bridge 24 tunnels to and from HAS. This arrangement works because the country firewall filters 26 will interpret that server's IP address as merely another server not tied to a blacklisted service or company. More specifically, when a user 12 wishes to use a Bridge node 24, the user 12 can use any hosting provider as long as the server is outside of a censored network. For example, Vultr Hosting VPS (virtual private server) or Amazon AWS EC2 can be utilized to create an inexpensive server instance and install the Bridge node 24. When creating a server (Bridge node 24) from these or other providers, that server receives an IP address from an IP pool owned by the provider. The IP address could have previously been used by any previous service or organization such as unicornsandrainbows.com or speedmetaldragracing.org. The probability of the server (Bridge node 24) being assigned an IP address that a country is blocking is incredibly small. If by chance the server is assigned an already blocked IP address, they can simply release and request a new one or delete the instance and create one elsewhere. A large majority of the time there would be no current DNS entry for this IP. Normally, the user 12 will connect by using the IP address and not an DNS address, this will further obscure the intended use of the server.

As further shown in FIG. 1, the Bridge 24 can be configured to tunnel and communicate to the client over any port using any supported encryption protocols. This will again further obscure the intended use of the server (Bridge node 24). Since the user 12 can configure to their liking or simply allow the software to randomly pick a configuration, fingerprinting traffic 16 moving to and from the server is virtually impossible. Because the Bridge 24 is highly configurable, collisions on identical Bridge configurations will be extremely unlikely. Even in the event that Bridge nodes 24 have the same configuration, their IP addresses will differ. Thus, the traffic 16 will appear as any other normal TCP/UDP. If the Bridge 24 the user 12 is using is blocked, that Bridge node 24 can be deleted and another established using a different configuration and provider.

With reference to FIG. 2, a more detailed HAS-request distribution 110 is shown. This view most clearly shows how user requests 116 are processed within a CDIPC 128 between a user 112, a Branch 132, a Stem 130, Leaf nodes 122, and a requested resource 11. Firewalls 126 depicted in this chart serve multiple roles: (1) the firewalls 126 can be located within a censored or locked region wherein outside or external users 112 are sending or receiving data from within the area, or (2) the firewalls 126 can be outside of the censored region and users 126 on the inside of the censored region can send or receive data to the outside. Still further, the firewalls 126 can be a network firewall from an operator of one of the Leaf Nodes 122. In some embodiments, Leaf nodes 122 can use Bridge nodes 124 to process requests 116.

As further shown in FIG. 2 and briefly introduced above, the HAS Fabric 110 broadly includes the client user 112, the optional Bridge Node 124, the Branch Node 132, the Stem Node 130, and one or more Leaf Nodes 122. HAS provides a packet tunneling protocol and system in which users 112 may connect via a Standard Web Browser or a Locally Installed HAS Client, which is explained in greater detail below.

Connecting via a Standard Web Browser requires no special client-installed software. The connection as shown in FIG. 2 is facilitated by the browser or the OS (operating system) without any need to modify the browser or OS, and each request/packet 116 enters the HAS Fabric. When connecting via a Locally Installed HAS Client, users 112 may select a comprehensive OS tunnel or a per-application tunnel. A per-application tunnel includes reconfiguring the OS in a specific manner according to the OS manufacturer and type, which depending on the OS, may be implemented as follows in any combination to re-route packets 116 from an application into the HAS client:
Virtual Ethernet Pair
Containers
Packet Tagging/Marking
TunTap devices or variants thereof
Firewalls reconfigured/Created
Raw networking socket protocols
Kernel Modules/Drivers
Modification of the applications networking stack
Static/Persistent Routes

In any mode, the packets 116 as depicted in FIG. 2 are being acted upon starting at OSI layer 2. Layer 2 is processed by the Leaf 122 and/or the HAS client whereas r2b servers work with Layer 3 or higher. Once a packet 116 enters the HAS client, OSI layer 2 is preserved and stripped from the payload (it can also send the payload containing OSI Layer 2 but is normally stripped for better efficiency). This arrangement does not tunnel into work like a standard B2B (Business to Business) VPN, which would arrange for a user computer to communicate as if the user were physically present onsite. In contrast, the inventive HAS gets into and out of hostile territory. However, B2B traffic can ride within the Beanstalk network without issue. The packet 116 is then encapsulated into another packet with specific HAS instructions. The packet is compressed (or not) and encrypted with either TLS or other cryptographic algorithms. The type of encryption implemented is dependent on a user's configuration settings and/or how the user 112 is connecting to the HAS servers. The client 112 (here, HAS application installed locally) operates in a duplex manner and facilitates any number of concurrent applications and services. To the applications or services being routed over HAS, the HAS client using the HAS local client application becomes the equivalent of what would be the local network adapter.

Operating in any of the available modes, per-application, route, or service based, any Network traffic not selected to run over the HAS will be routed over the normal networking protocols specified on the host, which in this context is the local host or client user; i.e., the local traffic that the user wants to send over HAS from the user device. The HAS packet is sent to the HAS servers. This is again dependent on how the user 112 is connecting to the HAS server fabric. Here, HAS servers and r2b servers are the same. The r2b servers host the HAS services as well as the Beanstalk VPN services on the same physical node. The HAS Fabric 110 encompasses all elements wherein:
r2b server hosting the HAS service (Branch+Stem servers)
Leaf node
Optional Bridge node
Client optionally using the Local HAS client program (not the Leaf Node)
Datacenter WANIPC

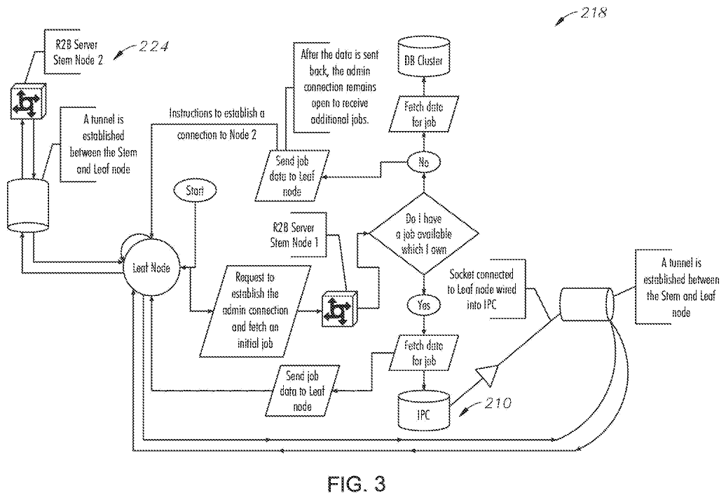

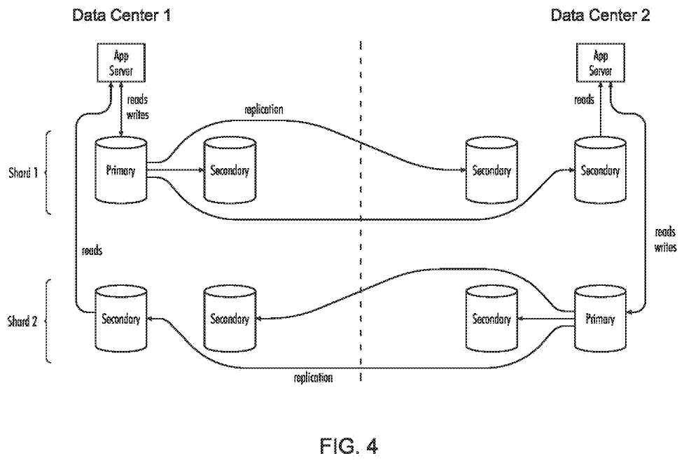

Once the packet 116 has been processed and a response has been sent from the HAS Fabric 110, the HAS client receives the response. It reassembles the packet 116 into an OSI Layer 2 frame. Modifying OSI Layer 2 to form a proper response, the frame is sent back to the application. Basically, when a packet arrives from the application to the HAS local client/program, the ethernet frame contained a source and destination MAC address. Depending on the technologies used, the packet/frame is received by the HAS local client. It removes and saves Layer 2 and sends Layers 3 and up to the Branch Node. The Branch node sends back a response with the requested data. The local HAS client removes the HAS packet/frame which contains the application's Layer 3 packet/frame. The local HAS client then builds a new Layer 2 frame changing the source and destination (some data is used from the saved layer 2 frame). Then it re-calculates all checksums and returns it to the application as a response without the application awareness. At no point is the payload of a packet 116 inspected or decrypted. Extraction details and exemplary code to accomplish this anonymity are shown and described in detail below in Extractions (1) through (8B) and in FIGS. 3 and 4. Thus, the integrity and secrecy of the content being requested and/or sent is maintained at all times through all parts of the HAS Fabric 110.

The Bridge node 124 in FIG. 2 is a scaled down server application. It is free of charge and any user 112 may obtain one. The purpose of the Bridge node 124 is to allow users 112 to host their own access point into the HAS Fabric. This access point or Bridge node 124 is private and known only to the user 112. It will tunnel the user's packet traffic 116 from any device (e.g., Bridge 124) into HAS Fabric servers. For example, a user 112 in a region whose government and/or ISP has blocked access to well-known addresses of the HAS Fabric can create the Bridge 124 into the HAS Fabric. The Bridge 124 will appear as any ordinary server. The Bridge 124, which aims to be as non-technical as possible to the user 112, supports an encrypted tunnel out of the hostile region into the HAS Fabric. From there, HAS will operate as normal.

With further reference to FIG. 2, the user 112 can directly connect to the Branch Node 114 or via the load balancer 114. The user 112 may also use the Bridge Node 124 to connect directly or to any load balancer 114. Whichever way the user 112 connects, the Branch Node 132 is the main entry point into the HAS Fabric. It is connected to the Stem server 130 (explained in further detail below) over an IPC memory channel 134. The Branch Node 132 has the responsibility of chunking and managing incoming requests 116 from a client connection. An exemplary process for creating the Bridge node 124 and the Stem Node 134 are shown and described below in code extractions 1-3. A purpose-built memory structure has been created to facilitate CDIPC 128 as well as the local IPC 134. Each request 116 is pushed into a memory structure of the WANIPC 128, as well as a horizontally and/or vertically distributed database cluster. See, e.g., FIG. 4 showing a multi-DC-DB, discussed below.

More specifically, when a request 116 is being processed by one of the Leaf Nodes 122 through the use of IPC 134 and WANIPC 128, a direct in-memory bridge/tunnel is produced between all parties, as shown for instance in FIG. 2. Here, the database cluster is linked and shared with other datacenter clusters. There exists one database cluster per data center. Data center clusters are distributed geographically. HAS servers are added or removed depending on real-time load. This relatively complex process of establishing an in-memory bridge between all parties occurs for each request 116.

More particularly, a request 116 is defined herein as a resource being requested over TCP/UPD protocols, which may or may not contain sub-requests to build the original request. Examples of such requests 116 would be:
1. A web browser is used to request mysite.com 11 as shown by way of example in FIG. 2.
   This is the main encompassing request that can be transmitted over secure protocols but is not required.
2. A 301-redirect response is issued to https://www.mysite.com
3. The browser then requests https://www.mysite.com._11.
4. After receiving the response for https://www.mysite.com 11, the browser is instructed to make an additional fifty (50) requests (for this example) to finish building the original request for https://www.mysite.com 11.
   The additional requests may range from CSS, JavaScript files, images, and video feeds, et cetera.
   In the event of video streams or feeds, each segment of a video may be managed in sub-requests.
   The additional requests may each contain further sub-requests, which in turn may contain an unspecified number of recursive sub-requests; i.e., a top-level resource request may have a multitude of sub-requests, all anonymous to the resource 11.
5. After all synchronous sub-requests are processed, the requested resource 11 begins to display to the user 112.
   Asynchronous requests may be running and making additional sub-requests to continue loading content and resources.

Every request 116 as broadly depicted in FIG. 2 has the opportunity to be processed by an individual Leaf Node 122. Order is not enforced, and there is no guarantee that the same Leaf node 122 will not process more than one of the specified requests. Requests 116 are indicated to the Leaf Node 112 over the persistent connection the Leaf Node 112 established with the Stem Node 130. Each Leaf Node 122 constitutes a unique IP address. In the example of Mysite.com 11, the resource 11 would perceive unique hosts and IP addresses for each segment of the top-level site request 116.

Thus, FIG. 2 shows that server and tracking software on the server hosting mysite.com 11 will read hundreds or thousands of unique IP addresses requesting the various parts of a particular web page 11. Accordingly, the HAS Fabric makes tracking a user's location (excluding GPS) identity insurmountably difficult if not impossible. When using a device with location abilities, a user could disallow location services to the application while using HAS, or simply disable location services. HAS does not remove tracking cookies or the like. It does not need to, but if the user 112 desires the most security, the user 112 should use a browser or plugin that would facilitate such actions.

FIG. 2 further shows the Stem Node 130 briefly introduced above, which is the counterbalance to the Branch Node 132. The Stem Node 130 facilitates the other half of the IPC 134 and WANIPC 128 HAS Fabric and is responsible for:
1. Fetching jobs 116 for the Leaf Nodes 122 to process.
   A. Processing occurs by querying the DB cluster. The DB cluster may contain an in-memory engine that is sharded between the clusters. The data contained in the DB record contains, the users request and additional meta data about the request. The metadata details the Branch Node 132 owner of the request and additional information such as the memory layout needed to establish the CDIPC between the Client 112, Branch 132, Stem 130, and Leaf Node 122.
   B. When the Leaf Node 122 connects to a Stem Node 130, the Leaf Node 122, establishes a persistent duplex network connection to the Stem Node 130. Establishing the persistent network pipe includes:
      i. Establish a connection to ANY Stem Node 130
      ii. No open ports from the location of a Leaf Node 122 are required.
      iii. No configuration other than installing the software and registering the Leaf Node 122 to an account is needed.
      iv. Authenticate and link to a valid account.
   C. Once the duplex pipe has been established between the Stem Node 130 and the Leaf Node 122:
      i. The pipe is used as an administrative bidirectional communication channel between the Stem Node 130 and the Leaf Node 122.
      ii. The Stem Node 130 indicates (sends) jobs 116 to the Leaf Node 122.
      iii. The Leaf Node 122 then dispatches the jobs 116 to sub workers/threads that establish connections to the Stem Nodes 130 who's Branch Node 132 owns the job 116.
2. The Stem node 130 is also responsible for tracking the expire time for a request 116.
   A. The WANIPC 128 between the Client 112, Branch Node 132, Stem Node 130, and Leaf Node 122 must be established relatively quickly. If too much time elapses between when a request 116 is created and when the WANIPC 128 tunnel has been established, the WANIPC 128 tunnel must be deconstructed and aborted because the HAS does not use redundancy for processing requests.
      i. HAS relies entirely on the underlying TCP/UDP protocol.
      ii. TCP/UDP protocols have their own methods for dealing with lost or dropped packets.
      iii. Once the tunnel has been established between all parties for the requests, HAS monitors OSI layer 4.
         HAS reacts in a JIT (Just in Time) manner. HAS can see all actions taken by the underlying transport protocol and react appropriately without slowing down the data flow, which is analogous to passing a car on a freeway.

With continued reference to FIG. 2, each Leaf Node 122 is in essence the simple basis of the HAS Fabric. As introduced above, each Leaf Node 122 requests/receives a job 116, processes the job 116, and moves on to the next request 116. Isolating the Leaf Node 122 from anything other than the Job(s) 122 to be processed prevents the Leaf Node 122 or the operator of the Leaf Node 122 from gaining insight into the origination and contents of the request 116. This is exemplified in the following instructions or extractions labeled (1) through (8B) for discussion purposes.

Extraction (1) begins at the point of which a user or a leaf node would be connecting to their respective Branch or Stem server. This processing loop is the event loop for the request factory(s). Bitwise flags set in previous steps (which fall outside the scope of this proof) indicate which factory should assume ownership over the connection.

Extraction (1)

```
while(1)
{
  if(poll(&m_serverPollFDS[m_pollSocketFDIndex], 1, SV_WAIT) > 0 &&
    m_serverPollFDS[m_pollSocketFDIndex].revents & POLLIN)
  {
    // If connection fd is good, then hand off to the factory and get next request
    m_serverPollFDS[m_pollSocketFDIndex].revents = 0;
    if((m_clientFD = accept(m_serverFD, ( struct sockaddr * )&m_clientAddress,
&m_socketInetSize)) == −1)
    {
      continue;
    }
    else
    {
      if((mode & M_BRANCH) && (mode & M_TLS) && !(mode & M_TT))
      {
        std::function<void(int32_t, SSL_CTX *, mongocxx::pool *, std::string, uint16_t)>
req_factory_p =
          bind(
            &skp::sock::ext::branch::HTTPS::httpsReqFactory,
            skp::sock::ext::branch::HTTPS(m_loggerID),
            _1,
            _2,
            _3,
            _4,
            _5);
        std::thread *t = new std::thread(
          req_factory_p,
          m_clientFD,
          m_sslCtx,
          pool.get( ),
          m_boundServerIP,
          m_boundServerPort);
        serverReqPush(sv_req_llst, t, t−>get_id( ));
      }
      else if((mode & M_STEM) && (mode & M_TLS) && !(mode & M_TT))
      {
        // Client + Branch + Leaf need to be connected by a STEM
        // Get the ip of the leaf
        std::string leaf_ip = getClientAddr(&m_clientAddress);
        std::function<void(int32_t, SSL_CTX *, mongocxx::pool *, std::string,
std::string)> req_factory_p =
          bind(
            &skp::sock::ext::stem::HTTPS::httpsReqFactory,
            skp::sock::ext::stem::HTTPS(m_loggerID),
            _1,
            _2,
            _3,
            _4,
            _5);
        std::thread *t =
          new std::thread(req_factory_p, m_clientFD, m_sslCtx, pool.get( ),
m_boundServerIP, leaf_ip);
        serverReqPush(sv_req_llst, t, t−>get_id( ));
      }
    }
  }
}
```

As shown in Extraction (1) above, the call to the serverReqPush function is a wrapper around the IPC memory structure's internal functions which uses SLT atomic access for adding links to the memory chain. This IPC is internal to the Branch and Stem server processes/threads but is exposed to the Leaf nodes and client through the use of CDIPC and or WANICP.

Extraction (2) is a complete https/TLS request factory function on the Branch (Client connection) side. This is the called function from extraction_1:Branch Server. As shown in the instructions below a secure TLS connection is established between the Client and the Branch server. The debugging code is only present when the application is compiled in debug mode. All production code is compiled as a release and all debug code is stripped or disabled. No debug output is allowed on production systems as this output could reveal sensitive information.

Extraction (2)

```
void HTTPS::httpsReqFactory(int32_t cfd, SSL_CTX *ctx, mongocxx::pool *pool,
std::string sv_ip, uint16_t sv_port)
{
  using namespace std::placeholders;
  // Init this ssl connection with the client and call proxyReqFactory
  if((m_ssl = SSL_new(ctx)) == NULL)
  {
    m_sslError = true;
    ERR_print_errors_fp(stderr);
  }
  if(m_sslError || SSL_set_fd(m_ssl, cfd) <= 0)
  {
    m_sslError = true;
    ERR_print_errors_fp(stderr);
  }
  if(m_sslError || SSL_accept(m_ssl) <= 0)
  {
    m_sslError = true;
    ERR_print_errors_fp(stderr);
  }
  if(!m_sslError)
  {
    // Before allowing the request to be processed,
    // verify the user has authenticated or is authenticating.
    std::string rpacket = “”;
    bool client_authenticated = false;
    skp::sock::ext::Base::socketRecv(cfd, rpacket, true, true);
    std::unique_ptr<skp::sock::Base::HttpPacket_t> packet = parseHttpPacket(rpacket);
    // Authenticate the client
    if((client_authenticated = isAuthClient(cfd, packet.get( ), pool)) == true)
    {
      proxyReqFactory(cfd, std::move(packet), rpacket, pool, sv_ip, m_ssl);
    }
    else
    {
      LOG_DEBUG(m_loggerID) << “Client Request did NOT properly authenticate”;
    }
    // Update the database with the total client usage for this request.
    if(m_totalBytesClient > 0 && client_authenticated)
    {
      bsoncxx::oid oid = m_authBasic−>m_mongoClient−>getClientId( );
      std::function<void(int64_t, mongocxx::pool *, bsoncxx::oid)> total_usage =
        bind(&skp::mongo::Client::insertBytesUsed, std::move(m_authBasic−
>m_mongoClient), _1, _2, _3);
      std::thread *t = new std::thread(total_usage, m_totalBytesClient, pool, oid);
      t−>detach( );
      delete t;
    }
  }
  close(cfd);
  // Omitted code
  return;
}
```

If the user/client has properly authenticated for this request, as shown in extraction (2) above, the proxyReqFactory function is called to start the transmission of data/packets. After the transmission of the data has completed, the database is updated with the number of bytes the user/client had used for this request. Nothing is tracked other than the number of bytes used per requests.

The execution flow in extraction (2) continues, and this request is removed from the IPC doubly linked list represented as the variable sv_req_llst. This embodies the SLT mentioned in extraction (1) above and elsewhere herein.

Extraction (3) is a complete proxyReqFactory function for the Branch server node. Depending on how the packet was sent to the Branch node, the authentication may need to be removed from the request headers. As shown below this request's socket, which is directly connected to the client/user, is now wired into the internal IPC between the Branch node and Stem Node. This routine establishes the IPC entry for this request and awaits a connection/transmission form a Leaf Node.

Extraction (3)

```
void Branch::proxyReqFactory(
  int32_t cfd,
  std::unique_ptr<skp::sock::Base::HttpPacket_t> packet,
  std::string &rpacket,
  mongocxx::pool *pool,
  std::string sv_ip,
  SSL *cfd_ssl)
{
  // Strip the proxy auth from the header | Omitted code
  std::pair<std::string, std::string> uri = getHostAndService(packet.get( ));
  std::string host = uri.first;
  std::string port = uri.second;
  // Error checking | Omitted code
  // Push into the q tracking 1st
  struct BranchOpenRequest_t *req = branchOpenRequestPush(open_req_llst, cfd);
  std::stringstream req_addr;
  req_addr << &(*req);
  // Push request into the branch db and CDIPC
  if(!m_mongoBranch−>insertNewReq(cfd, pool, rpacket, sv_ip, req_addr.str( )))
  {
    branchOpenRequestPop(open_req_llst, req);
    return;
  }
  // Update the ssl object for the client fd
  req−>cfd_ssl = cfd_ssl;
  // Wait for a leaf to connect to a stem and complete the request
  std::chrono::steady_clock::time_point start_time = std::chrono::steady_clock::now( );
  while(!req−>fin)
  {
    if(thread_exit)
    {
      break;
    }
    std::chrono::duration<double> time_span;
    time_span =
std::chrono::duration_cast<std::chrono::duration<double>>(std::chrono::steady_clock::now(
) − start_time);
    // Time is over 30 seconds and no leaf has been set
    if(( int32_t )(time_span.count( )) > 30 && req−>lfd == −1)
    {
      break;
    }
    Sleep(2);
  }
  m_totalBytesClient = req−>bytes_c;
  // Cleanup | Omitted code
  branchOpenRequestPop(open_req_llst, req);
  return;
}
```

As further shown in extraction (3) above, the Branch node's thread waits for a Leaf node to connect to a Stem Node and take ownership over the processing of this request. If no leaf node takes ownership, then the request is aborted. Finally, the total number of bytes used on the client/user side are set and the function cleans up its portion of the request.

Turning now to Extraction (4), the Stem side of the operation is explained. As shown below, entry is the same as extraction_(2) but now within the context of the Stem+Leaf. The notable differences are the added routines to check what the Leaf node is trying to do and the database operations to track the bytes the Leaf node processes.

Extraction (4)

```
void HTTPS::httpsReqFactory(int32_t lfd, SSL_CTX *ctx, mongocxx::pool *pool,
std::string sv_ip, std::string leaf_ip)
{
  // Init this ssl connection with the client and call proxyReqFactory | Omitted code, same as
branch
  if(!m_sslError)
  {
    std::string rpacket = “”;
    bool leaf_authenticated = false;
    bool is_admin_conx = false;
    skp::sock::ext::Base::socketRecv(lfd, rpacket, true, true);
    if(rpacket.empty( ))
    {
      goto _{——}conx_term_{——};
    }
    std::unique_ptr<skp::sock::Base::HttpPacket_t> packet =
skp::sock::ext::Base::parseHttpPacket(rpacket);
    if((leaf_authenticated = isAuthLeaf(lfd, packet, pool, leaf_ip)))
    {
      if(m_authLeaf−>validIP(leaf_ip, pool))
      {
        // Get the intent of the leaf
        std::string intent = skp::sock::ext::Base::getHeaderValue(packet−>gen_header,
skp::http::Stem::STEM_INTENT);
        if(intent == skp::http::Stem::getHttpHeader(skp::http::Stem::PROCESS_JOB))
        {
          // Process the job
          processJob(lfd, pool, sv_ip, leaf_ip, std::move(packet));
        }
        else if(intent ==
skp::http::Stem::getHttpHeader(skp::http::Stem::ESTABLISH_LEAF_DISPATCH))
        {
          // This thread becomes a persistant connection between the Stem and the Leaf
          is_admin_conx = true;
          doLeafAdmin(
            lfd,
            pool,
            leaf_ip,
            m_authLeaf−>m_mongoLeaf−>getLeafOID( ),
            m_authLeaf−>m_mongoLeaf−>getSessionToken( ));
        }
      }
    }
    // Update the database with the total data processed by the leaf for this request.
    if(!is_admin_conx && m_totalBytes_1 > 0 && leaf_authenticated)
    {
      std::function<void(int64_t, mongocxx::pool *, bsoncxx::oid, bsoncxx::oid)>
total_usage = bind(&skp::mongo::Leaf::insertBytesUsed, _1, _2, _3, _4);
      std::thread *t = new std::thread(
        total_usage,
        m_totalBytes_1,
        pool,
        m_authLeaf−>m_mongoLeaf−>getLeafOID( ),
        m_authLeaf−>m_mongoLeaf−>getLeafAccountOID( ));
      t−>detach( );
      delete t;
    }
  }
_{——}conx_term_{——}:
  close(lfd);
  // Clean up | Omitted code
  return;
}
```

The following extraction (5) details the connecting of the Leaf node into the IPC of the Branch and the Stem, which facilitates the communication directly to the client/user. Beginning at line 19 an unassigned job is fetched. If the Stem owner of the job is the current host, the conditional on line 26 is entered. If not, the Leaf node is instructed to connect the Stem server which owns the job. To recap, the Leaf received the initial request over its admin connection to a Stem Node, and the leaf then dispatched a sub worker to start processing the request. When the processJob function is entered, the initial response to the request is received. This function therefore establishes the IPC between the Stem's IPC to the Branch and the Leaf Node, and triggers the transmission of data between all parties.

Extraction (5)

```
void Stem::processJob(
  int32_t leaf_fd,
  mongocxx::pool *pool,
  std::string &sv_ip,
  std::string &leaf_ip,
  std::unique_ptr<skp::sock::Base::HttpPacket_t> packet)
{
  if(&(**open_req_llst) == 0)
  {
    return;
  }
  // master_ip, json
  bsoncxx::oid job_id(skp::sock::ext::Base::getHeaderValue(packet−>gen_header, “Job-
Id”));
  if(job_id.to_string( ) == NULL_OID)
  {
    badRequestResp(leaf_fd);
    return;
  }
  std::pair<std::string, const std::string> job = m_mongoStem−>getJobStem(pool, job_id);
  if(job.first == “” || packet−>payload.empty( ))
  {
    noContentResp(leaf_fd);
    return;
  }
  if(!thread_exit && job.first == sv_ip)
  {
    // The leaf is sending the initial response from the request it had dispatched to a sub
worker
    // connect to the pointer in the open req_llst that == fd, tunnel data
    bsoncxx::document::value val = bsoncxx::from_json(job.second);
    bsoncxx::document::view payload_v = val.view( );
    int32_t cfd = payload_v[“ref_fd”].get_int32( ).value;
    std::string req_addr =
payload_v[“request_address”].get_utf8( ).value.to_string( );
    BranchOpenRequest_t *req = nullptr;
    if((req = branchOpenRequestFind(open_req_llst, cfd)) == nullptr)
    {
      badRequestResp(leaf_fd);
      return;
    }
    // If the mem addresses dont match, abort
    if(( uint64_t )(&(*req)) != stoul(req_addr, nullptr, 16))
    {
      badRequestResp(leaf_fd);
      return;
    }
    // Assign the leaf_fd to the IPC for this request
    branchOpenRequestUpdate(req, leaf_fd);
    // While we get data from the leaf, tunnel it to the client then, End all sides of the
tunnel, let branch clean up the req llist
    setLeafIp(leaf_ip);
    stemTunnel(req, packet−>payload);
    req−>fin = true;
  }
  return;
}
```

The memory address of the link in the IPC doubly linked list is also established, as well as a pointer to the IPC link. Validation of the memory addresses for the IPC link must match the one contained in the request from number 3. If all validations pass, the Leaf node is assigned ownership of the request/job, and the tunnel is established that facilitates the direct communication between the User+Branch+Stem+Leaf.

The following instructions (Extraction (6A)) detail where Extraction (5) enters the stemTunnel function.

Extraction (6A)

```
std::function<bool(void)> get_from_1 = [&](void) {
  // Get from leaf
  int32_t tov = 45;
  if(poll(&pfds[idx_lfd], 1, tov) > 0 && pfds[idx_lfd].revents & POLLIN)
  {
    pfds[idx_lfd].revents = 0;
    if((recv_count = recvLeaf(leaf_fd, &buff, MAX_READ_SIZE, 0)) <= 0 || thread_exit)
    {
      goto no_data_ret;
    }
    // Send to client
    if(poll(&pfds[idx_cfd], 1, POLL_TV_MAX) > 0 && pfds[idx_cfd].revents &
POLLOUT)
    {
      pfds[idx_cfd].revents = 0;
      std::string data(( char * )buff, 0, recv_count);
      std::unique_ptr<skp::sock::Base::HttpPacket_t> packet = decodePayload(data);
      // Check for status codes from the leaf
      if(skp::sock::ext::Base::getHeaderValue(packet−>gen_header, “Connection”) ==
“close”)
      {
        // This indicates no more will be sent on this socket from the leaf, exit now.
        leaf_fin = true;
        m_totalBytes_1 += recv_count;
        open_req−>bytes_c += recv_count;
        goto no_data_ret;
      }
      // Check for a partial packet | Omitted code
      if(packet−>payload_ptr.second > 0)
      {
        sendClient(
          ( uint8_t * )packet−>payload_ptr.first.get( ),
          packet−>payload_ptr.second,
          open_req−>cfd_ssl);
        m_totalBytes_1 += packet−>payload_ptr.second;
        open_req−>bytes_c += packet−>payload_ptr.second;
      }
      else
      {
        goto no_data_ret;
      }
    }
    no_data = 0;
    return true;
  }
  else
  {
    goto no_data_ret;
  }
no_data_ret:
  return false;
};
```

As shown in extraction (6A) above, while extraction (5) has just sent the Leaf node the request/job, extraction (6A) details the receiving and sending of data between the Leaf node and the client/user by means if WANIPC and or CDIPC. The code reads from the Leaf node and sends the data to the user.

As further shown in extraction (6A), the function recvLeaf is a pure virtual function. C++ language specification may be consulted for additional details. This allows a single receive from leaf function call to embody any number of supported protocols and procedures that may act on any level of the OSI networking protocols. This model abstracts away the complexities of processing the underlying protocols into a simple function call. Basically, the recvLeaf function handles the reception of new data on the IPC to and from the leaf node.

Turning now to extraction (6B), these instructions detail where extraction (6A) would have sent a packet/payload to the user/client.

Extraction (6B)

```
std::function<bool(void)> get_from_c = [&](void) {
  // Get from client
  int32_t tov = 45;
  if(poll(&pfds[idx_cfd], 1, tov) > 0 && pfds[idx_cfd].revents & POLLIN)
  {
    pfds[idx_cfd].revents = 0;
    if((recv_count = recvClient(&buff, MAX_READ_SIZE, open_req−>cfd_ssl)) <= 0 ||
thread_exit)
    {
      goto no_data_ret;
    }
    // Send to leaf
    if(poll(&pfds[idx_lfd], 1, POLL_TV_MAX) > 0 && pfds[idx_lfd].revents &
POLLOUT)
    {
      pfds[idx_lfd].revents = 0;
      std::string payload;
      encodePayload(( uint8_t * )buff, recv_count, payload);
      sendLeaf(leaf_fd, ( uint8_t * )(payload.c_str( )), payload.size( ), 0);
      open_req−>bytes_c += recv_count;
    }
    no_data = 0;
    return true;
  }
  else
  {
    goto no_data_ret;
  }
no_data_ret:
  return false;
};
```

The foregoing function reads the response from the user and sends the data to the Leaf node. More specifically, a function called encodePayload is shown above that adds HAS headers and need frames around the user's payload/packet and, as with decodePayload, does not modify the user's data. The function encodePayload is further detailed in extraction (7B) below and decodePayload is further detailed in extraction (7A).

Also, in extraction (6B) above is the function “recvClient”. This is a pure virtual function that handles the reception of new data on the IPC to and from the client. See C++ language for more details. The recvClient function allows a single receive from client function call to embody any number of supported protocols and procedures that may act on any level of the OSI networking protocols. This model abstracts away the complexities of processing the underlying protocols into a simple function call.

Extraction (7A) details the decodePayload function briefly introduced in extraction (6A). As shown below, the data is collected and once a completed payload has been received, the HAS request/packet is removed and the user's data is decoded (in this example, using base64).

Extraction (7A)

```
std::unique_ptr<skp::sock::Base::HttpPacket_t> TunnelBase::decodePayload
(
  std::string &raw_data,
  skp::sock::Base::HttpPacket_t *segment // = nullptr
)
{
  if(segment != nullptr)
  {
    segment−>payload.append(raw_data);
    if(segment−>payload_sz == segment−>payload.size( ))
    {
      LOG_DEBUG_V << “Clearing fragmented payload flag”;
      segment−>partial_payload = false;
      segment−>payload_ptr = skp::Crypto::base64Decode(segment−>payload);
      segment−>payload = “”;
    }
    return nullptr;
  }else
  {
    std::unique_ptr<HttpPacket_t> packet = skp::sock::Base::parseHttpPacket(raw_data);
    if(packet−>payload != “”)
    {
      std::string psize = skp::sock::Base::getHeaderValue(packet−>gen_header, “Payload-
Size”);
      if(psize != “”)
        packet−>payload_sz = stoi(psize);
      else
        return move(packet); // Invalid packet: A return here will abort the connection
      if(packet−>payload_sz == packet−>payload.size( ))
      {
        packet−>payload_ptr = skp::Crypto::base64Decode(packet−>payload);
        packet−>payload = “”;
      }else
      {
        LOG DEBUG_V << “Setting fragmented payload flag”;
        packet−>partial_payload = true;
      }
    }
    return move(packet);
  }
  return nullptr;
}
```

Extraction (7B) details the encodePayload function introduced in extraction (6B).

### Extraction (7B)

As shown above the user's data is encoded and/or compressed and placed into a HAS request/packet. The HAS request/packet can contain additional information and instructions. The encodePayload can have many overrides that use different encoding/compression, but the underlying principals are the same.

Extraction (8A) details the Leaf nodes handling of user data moving from the Stem Node to the remote target.

Extraction (8A)

```
std::function<bool(void)> get_from_s = [&](void) // Get from stem
{
  if(HAS_POLL(&pfds[idx_stem_fd], 1, 300) > 0 && pfds[idx_stem_fd].revents &
POLLIN)
  {
    pfds[idx_stem_fd].revents = 0;
    if((recv_count = _recv(stem_fd, ( HAS_SR_BUFF_TYPE )&buff, MAX_READ_SIZE,
0, m_ssl)) <= 0)
    {
      return false;
    }
    // Send to target
    if(HAS_POLL(&pfds[idx_tfd], 1, POLL_TV_MAX) > 0 && pfds[idx_tfd].revents &
POLLOUT)
    {
      pfds[idx_tfd].revents = 0;
      std::string data(( char * )buff, 0, recv_count);
      std::unique_ptr<HttpPacket_t> packet = decodePayload(data);
      // Check for a partial packet
      while(packet−>partial_payload)
      {
        if(HAS_POLL(&pfds[idx_stem_fd], 1, POLL_TV_MAX) > 0 &&
pfds[idx_stem_fd].revents & POLLIN)
        {
          pfds[idx_stem_fd].revents = 0;
          if((recv_count = _recv(stem_fd, ( HAS_SR_BUFF_TYPE )&buff,
MAX READ_SIZE, 0, m_ssl)) <= 0)
          {
            return false;
          }
          std::string data_seg(( char * )buff, 0, recv_count);
          decodePayload(data_seg, packet.get( ));
        }
      }
      if(packet−>payload_ptr.second > 0)
      {
        // NOTE: Do not send over our TLS
        _send(
          target_fd,
          ( HAS_SR_BUFF_TYPE )packet−>payload_ptr.first.get( ),
          packet−>payload_ptr.second,
          0);
      }
      else
      {
        return false;
      }
      no_data = 0;
      return true;
    }
  }
  return false;
};
```

As shown above in Extraction (8A), the payload will be processed by the Stem server and returned to the user as stated in Extractions (5) and (6A) above. Functions _send and _recv abstract away the protocol specifics and allow the leaf node to simply transmit data to and from the Stem Node. Here again, C++ language specification may be consulted for pure virtual functions such as the function _recv found on lines 3, 5, and 23, and the function _send at line 36. Further, the decodePayload function calls are the same as stated in Extraction (7A).

Extraction (8B) below details the Leaf nodes handling of the data moving from the remote target to the Stem server, and concludes how the packet flow would not be apparent to the user.

Extraction (8B)

```
std::function<bool(void)> get_from_t = [&](void) // Get from target
{
  if(HAS_POLL(&pfds[idx_tfd], 1, 300) > 0 && pfds[idx_tfd].revents & POLLIN)
  {
    pfds[idx_tfd].revents = 0;
    if((recv_count = _ recv(target_fd, ( HAS_SR_BUFF_TYPE )&buff,
MAX READ_SIZE, 0)) <= 0)
    {
      return false;
    }
    // Send to stem
    if(HAS_POLL(&pfds[idx_stem_fd], 1, POLL_TV_MAX) > 0 &&
pfds[idx_stem_fd].revents & POLLOUT)
    {
      pfds[idx_stem_fd].revents = 0;
      std::string payload;
      encodePayload(( uint8_t * )buff, recv_count, payload);
      _send(stem_fd, (HAS_SR_BUFF_TYPE)(payload.c_str( )), payload.size( ), 0, m_ssl);
      no_data = 0;
      return true;
    }
  }
  return false;
};
```

As shown above the Stem server will process the data as stated in Extractions (6A) and (6B). And similar to the above _send and _recv functions from Extraction (8A), these functions abstract away the protocol specifics and allow the leaf node to simply transmit data to and from the remote resource.

The encodePayload function calls are the same as stated in Extraction (7B) but may contain different HAS arguments, and it will be appreciated that Extractions (8A) and (8B) detail only where the user's data/packet is processed and does not detail the other routines that call these functions.

Returning now to FIG. 2, architecture or inner workings of the Leaf node 122 include:
Depending on the uplink speed of the networking connection, the Leaf Node 122 may process more than one request 116 at a time.
The number of concurrent requests 116 is automatically determined when the Leaf Node 122 is started. Care is taken to ensure the operator's network remains responsive and functional for their uses outside of the HAS purposes. Specifically, when a leaf node is registered to an account, if no network profile exists for the IP address, an automatic network speed test is performed. Users can then select on a per Leaf node basis or globally the percentage of the upload link speed they wish to be consumed by the Leaf node(s). This percentage+upload quality (speed) also determines how many concurrent jobs the Leaf node is allowed to process. Users can have many leaf nodes registered to their account (assuming they have the legal authority/permission to run a leaf node on the internet connections). This ability to adjust the consumption rate will allow the operators of the leaf node to balance the nodes processing throughput with the other needs of that local network to prevent a given Leaf node from saturating the network to the point of being unusable. Still further, this prevents users from modifying the code to process more jobs than the network can realistically support to ensure that the entire Hive is running as fast as possible.

When the Leaf node 122 requests a job 116 to process, as introduced above it must:
A. Connect to a Stem Node 130. The Leaf Node 122 establishes a persistent duplex network connection to the Stem Node 130. Establishing the persistent network pipe includes:
   i. Establish a connection to ANY Stem Node 130
   ii. No open ports from the location of a Leaf Node 122 are required.
   iii. No configuration other than installing the software and registering the Leaf Node 122 to an account is needed.
   iv. Authenticate and be tied to a valid account.
B. Once the duplex pipe has been established between the Stem Node 130 and the Leaf Node 122:
   i. This pipe is used as an administrative bidirectional communication channel between the Stem Node 130 and the Leaf Node 122.
   ii. The Stem Node 130 indicates (sends) jobs 116 to the Leaf Node 122.
   iii. The Leaf Node 122 then dispatches the jobs 116 to sub workers/threads that establish connections to the Stem Nodes 130 who's Branch Node 132 owns the job 116.

As shown in FIG. 2 after the Stem Node 130 and the Leaf Node 122 have established a persistent administrative network connection the following occurs:
1. The Leaf Node 122 receives the requests 116 from the Stem Node 130.
2. For non-TLS/SSL requests, the following occurs:
   a. The connection between the Stem Node 130 and the Leaf Node 122 is always encrypted in one way or another.
      The connection between the Stem and Leaf is always encrypted by means of TLS or other encryption protocols. This is true even if the requested resource is not over an encrypted connection. Thus, if a user requests a site over HTTP (NOT HTTPS) the website would send the data in its unobscured form. The transfer of the data would be encrypted as it moves from the Leaf node to the Stem node then to Branch node and back to the client. But the data would not be encrypted from the target site to and from the Leaf node.
   b. Here, a non-TLS/SSL connection is defined as:
      A User 112 makes a request 116 for a resource 11 over a non-secure channel; e.g., a web resource is requested over HTTP (not HTTPS).
   c. A blind tunnel is established to the target resources and communication between the Client+Branch Node+Stem Node+Leaf Node+target is facilitated.
3. For TLS/SSL requests, the following occurs:
   a. Because Leaf nodes 122 receiving jobs/requests 116 to process is a naturally random process, and HAS chunks and distributes on a per-request basis, making a TLS handshake through the HAS network possible.
      This is “naturally random” due to the millions of possible outside forces causing delays or speedups of the Leaf Node 122 request processing. This provides HAS with an organic defense against its traffic being fingerprinted and tied back to user. In other words, HAS does not have a traceable pattern.
      More specifically, users—when using HAS with Leaf nodes—enjoy a naturally accruing obscuration of their network patterns “naturally random process” (NRP). This is due to latency for moving data over the internet. This latency can be increased or decreased by any number of outside factors and forces. Some examples are:
         1. Differing speeds and abilities of hardware on which HAS may be running.
         2. The OS software of which users and or the Leaf nodes are being facilized.
         3. The software running on the OS which users and or the Leaf nodes are competing with for system resources.
         4. ISP internet quality
         5. ISP outages
         6. The user's networking equipment
         7. System failures.
      Basically, the foregoing exemplary factors and their many possible combinations contribute to the NRP. Here, as HAS utilizes its Stem nodes for searching and facilitating requests, and as the Leaf nodes receive and process jobs, signatures are constantly changing, and there is no pattern. An illustrative example of the NRP is like a leaf blowing in the wind. If one were able to capture a body of leaves being blown by the wind with a picture, the next time the wind blew that same body of leaves, it would not be possible to capture an identical picture. This exemplifies how HAS obscures a user's identity, and the NRP that occurs by and within HAS. The user can make the same request over and over, but that request will never have the same identical fingerprint.
   b. Assuming an understanding of how a TLS connection is created and how a TLS session is resumed, when an initial client hello request 116 is created from the client end 112 and processed by the HAS fabric, a Leaf Node 122 takes ownership of the request 116.
   c. The Leaf Node 122 then establishes a blind tunnel to the remote target 11.
      More specifically, the Leaf node uses simple tunnel logic if the request's initialing side is connecting via a direct connect method, such as from a browser that supports https proxies or other “direct connect” methods. Direct connect in this manner does not use the local client on the user's device. In the case of direct connect (not using the local client), the Leaf node operates by using two kinds of blind tunnels:
         1. An HTTP Connect type tunnel
         2. An HTTP Forward type tunnel
      HTTP Connect is the more complicated of the two and is normally used when an application is aware that it is sending data over a proxy; for example, when the user is connecting by their browser and not using the local HAS client/application.
         1. The user's application would send an HTTP CONNECT header. The header would contain the remote targets address and port.
         2. The Leaf node will establish a socket connection to the remote target and reply back the connection has been established.
         3. The user's application would start sending data/packets and the Leaf node will tunnel to and from the remote target until the request has been completed.
      Here, HTTP Forward is normally used when an application is unaware that it is transmitting over a proxy, for example, an insecure connection.
         1. The user's application would send the initial requests as it normally would to the remote target.
         2. When the Leaf node receives the job containing the request, it establishes a socket connection to the remote hosts but does not respond back to the user (i.e., through the HAS fabric to return to the user). Instead, the Leaf node immediately sends the users packet to the remote target.
         3. It then receives and sends to and from each side until the requests are completed.
         4. See Extractions (8A) and (8B) above.
   d. The Leaf Node 122 then forwards the packet, in this case the TLS client hello.
   e. The Leaf Node 122 then receives the initial response from the remote target 11 and returns it to the client 112 over the established WANIPC 128 tunnel/pipe.
   f. At this point, the Leaf Node 122 does not close the connection and move on to another request to process; instead, the WANIPC tunnel 128 remains open and continues to forward the remaining steps/packets to and from the client 112 and to and from the remote target 11 to establish the TLS connection.
   g. Once the data ceases to flow, the tunnel is shut down and the Leaf node 122 continues to repeat the cycle of fetching and processing jobs/requests 116.
   h. Because the client 112 was able to establish a TLS connection to the remote target 11, it can now use the TLS session to make subsequent TLS requests that will each be processed by different Leaf Nodes 122, or depending on the server's configuration, a new TLS connection will be established.
4. In the event that the connection's initiating side is using the HAS local client, the received request will contain additional layers 3 and 4 networking frames. Because these frames are synchronized, the leaf node sends/injects the packet into the host's network kernel as if the host originated the packet. The host's kernel will then transmit the packet and receive the response. The response is then captured (the means of injection and capture are specific to the OS) and returned to the Leaf Node. Once the Leaf Node receives the packet is sends it back to the Stem Node as described previously.

Although the Leaf nodes 122 are simple, they are elegant in that each request they process can facilitate any kind of traffic due to creation of the WANIPC tunnels 128; e.g., file uploads, file downloads, video streams, et cetera. When a user 112 requests a web page for example, some requests have sub-requests that must be processed over the same tunnel and some requests are simplistic and will be processed by some random set of Leaf Nodes 122. Even some complicated requests that may take a long time to process but take a few seconds between the subsequent requests will be handled by multiple Leaf Nodes 122, depending on the nature of the request 116.

In the context of HAS, the WANIPC 228 provides a method of connecting multiple computing devices or data centers 212, which may or may not be geographically distributed, to each other's private memory space, so that they may freely communicate with each other.

As shown in FIG. 3, WANIPC 228 at a minimum consists of two or more disjoined computing devices 212. HAS facilitates WANIPC 228 by using a purpose-built, doubly linked list. The memory object has its own functions and locks for interacting with the object and its links in the memory chain. Each Branch and Stem Node pair have a single list they share over an internal IPC. A basic implementation appears as follows wherein the Branch and Stem Nodes form the core of the WANIPC 228.
1. A request is made from the client end.
2. The client's request creates a socket connection to the Branch Node.
3. The Branch Node then creates a new thread/process and a new link in the CDIPC doubly linked list.
4. Searching, adding, removing but NOT updating is controlled by a SLT (Simi Lockless Triplet) described in greater detail below.
   Because the working thread created the link in the list, it already has a pointer to the memory address and is the owner. It can update all data members and sub objects of that list, with the exception of the previous and next pointers to links in the chain without acquiring a lock on the object/link.
5. The request at this point is in a pending state, waiting for a Leaf Node to process the requests.
6. The Stem and Branch Nodes are connected by an internal IPC.
7. The Stem Node searches the list using SLT over its IPC with the Branch Node and finds an available job that is not currently being processed and sends the job back to the Leaf Node.
8. The Stem Node attaches a thread/process to the pointer of the IPC memory segment that holds the link in the list and also attaches a socket from the Leaf Node to the IPC memory segment.
9. Now we have a fully established memory pipe between the Client+Branch+Stem+Leaf.
10. When the Leaf Node sends back data, it writes to the socket which is connected to the Stem Node.
11. The Stem Node reads the payload. Then writes that to the IPC memory segment which contains a socket directly connected to the Client.
12. The Client responds over its socket which is connected to the Branch Node.
13. The Branch Node then writes to its IPC with the Stem Node which contains a socket directly connected to the Leaf Node.
14. The Leaf Node reads the response, and the cycle continues until the connection is terminated.

The SLT™ (Simi-Lockless Triplet) is the process of locking only the minimum number of links in a doubly linked list. Normally, when an item in a doubly linked list is added, searched, or removed, the user gains a lock (exclusive access) to the entire list. SLT provides simi-atomic access to the list. Exemplary scenarios include:
1. Adding and Removing items at list ends (the following is an example of Adding; Removing follows the same principals):
   a. If the item to be added will be added at the head (beginning) of the list:
      i. Each link in the list has its own mutex or locking flag.
      ii. A lock must be acquired only on the first (head) link termed “Link 1”.
   b. The new link, termed “Link 0” is pushed into the memory structure and linked into the list by:
      i. Currently Link 1's pointer to the next link in the list is pointed at the address of Link 2.
      ii. Currently Link 1's pointer to the previous link in the list is null.
      iii. Update Link 1's pointer to the previous link in the list to point to the address of Link 0.
      iv. Update Link 0's next pointer which is currently null, to point to the address of Link 1
      v. Link 0's previous address is null and will be updated if a new link is created at the beginning of the list.
      vi. The same logic applies to adding at the end of the list just in the reverse order.
2. Adding/Removing an item from anywhere but beginning or end (in this example, an item will be removed):
   a. As stated, each link has its own mutex or locking flag.
   b. For an item to be removed under the SLT context:
      i. A lock must be acquired on the link to be removed (Link 1).
      ii. A lock must be acquired on the link previous to the link to be removed (Link 2).
      iii. A lock must be acquired on the link next to the link to be removed (Link 3).
   c. Link 1's next pointer will be updated to no longer point to Link 2 but now to Link 3.
   d. Link 3's previous pointer will be updated to no longer point to Link 2 but now to link 1.
   e. Locks are released on links 1 and 3 and link 2 deleted.
3. Searching a list:
   a. Searching a list can start at the beginning or end, or if an address is known for an existing link in the list, go forward or backward from that point.
   b. This example starts at the beginning:
      i. A lock must be acquired on the head (beginning) of the list.
      ii. Then a lock must be acquired on the next link in the list from current position.
      iii. The lock on the current position is released and the cycle continues.
   c. If the searching process/thread wants to take ownership of the link at current position:
      i. Ownership can only be acquired if the link is not already owned.
      ii. Ownership controls are facilitated by the functions which are specifically built for interfacing with the memory structure.
      iii. If the process/thread takes ownership:
      iv. It calls the proper functions to gain ownership.
      v. It releases the lock on the link and stores a pointer to the link.

The foregoing generally describes the functionality of a standard, doubly linked list with the added simi-atomic access. The adding of the simi-atomic access to the list allows the HAS to function and allows HAS to expand its functionality; for instance:
1. Scenario 1: for an SLT to provide a high performance WANIPC, assume that a request has been completed; now the link in the list that facilitated the request needs to be removed. A new request has come in and needs to be push into the list.
   a. The link to be removed is 30 links down from head link.
   b. The thread/process which wishes to remove the link gets the required 3 locks to pop the link from the list.
   c. At the same time, the thread/process that wishes push a link into the list gets its required lock to push the link into the head of the list.
   d. They can both atomically access the list and change it.
2. Scenario 2: a simi-lockless, simi-atomic operation occurs because a request has been completed, and the link in the list that facilitated request needs to be removed. A Stem Node needs a job for a Leaf Node.
   a. The link to be removed is 30 links down from head link.
   b. The Stem Node starts its search from the beginning or end, but in this instance, we will use beginning.
   c. As required each link and its next link must be locked when searching, see above for more details.
   d. Both threads/processes can atomically access the list and change it.
   e. The searching thread can acquire a job and the popping thread can remove a job.

If the popping thread has not finished and released the locks before the searching thread reaches the 29th link, the searching thread will have to wait.

FIG. 3 more particularly shows the R2B-internal-CDIPC 210 and its functions/flows within a single DC 218. Broadly, an R2B server 224 is shown that acts as a Bridge node to process requests; i.e., the CDIPC 210. Also shown is an R2B Stem Node Request being processed with CDIPC fulfillment, e.g., CDIPC 210.

FIG. 3 represents the decision-making logic to decide if the Stem server the Leaf node is currently connected to owns the job/request. If it does, it will facilitate the processing of the requests. If not, it will send the job to the Leaf Node over the established “admin” network and the Leaf Node will then connect to the Stem Node that owns the job. The Leaf node will retain/maintain the “admin” connection to the original Stem Node. For example:
1. The Leaf node establishes a persistent duplex network connection to the Stem Node and sends a fetch job request to a Stem node.
2. The Stem Node indicates (sends) jobs to the Leaf Node.
3. The Leaf Node then dispatches the jobs to sub workers/threads that establish connections to the Stem Nodes whose Branch Node owns the job.
4. The Stem node initially checks to see if it has an available job that it owns. (All Stem nodes first attempt to self-serve their own requests before searching for requests outside of their direct control.)
5. If the Stem node has an available job of which it is the owner:
   a. The Stem node will collect needed data about the job.
   b. Wire/move the currently connected Leaf node's socket connection into the IPC link shared with the Branch node. More specifically, the Stem Node indicates (sends) the job to the Leaf Node over the “admin” network connection between them.
   c. Return the job data to the Leaf node. More specifically, the Leaf Node then dispatches the job to a sub worker/thread that establishes a connection to the Stem Node who's Branch Node owns the job
   d. Establish a tunnel between the Stem node and the Leaf node which uses the connections within the IPC link. More specifically, the Leaf Node's sub worker's connection is wired/patched into the IPC link shared with the Branch node.
6. If the Stem node does not have an available job of which it is the owner, one of the Leaf Node's sub workers, from which the job was dispatched, will connect to the Stem Node that is the job owner and steps 5c-5d above are executed.
7. The Leaf node retains its admin connection to the original Stem Node.
8. Although FIG. 3 does not expressly show job validation, validating the job/request is implied, and in this example, logic has been applied and all assumed to be valid. See extractions (4) through (8) herein for further details
9. A tunnel is established and the data/content for the request flows from the Leaf node to the user.
10. Once the request has been fully processed this non-administrative connection between the Stem and Leaf node is closed.

With reference now to FIG. 4, as briefly introduced above the concept of CDIPC communication over multiple DCs is shown; i.e., a Multiple Datacenter Unity/Bridge CDIPC or “multi-DC-DB.” These CDIPC connections are facilitated over a private and/or public NIC, which can be fiber or copper. Here, the App Server is the “router” of requests between the Shards and their replica sets. The replica sets can be distributed over multiple DC or contained within a single DC but remain accessible over any DC by the App Server. The Shards are groupings of replica sets and allows for horizontal distribution/growth. The vertical distribution/growth is achieved through increasing the computing resources of each DB node in the cluster. Accordingly, these means of distributing/replicating between DC a Stem can query for jobs that are outside of its own DC.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

By way of example and not of limitation, exemplary embodiments as disclosed herein may include but are not limited to:

### EMBODIMENT 1

A hybrid or hive anonymity system, comprising: a Branch node, a Stem node, a Leaf node, and a Bridge node, wherein the Branch node includes a connection to a client or to a load balancer, wherein the Stem node is a point to which the Leaf node connects, wherein the Leaf node is one or more random, geographically distributed affiliate points being configured to request a payload to process from the Bridge node, and wherein the Bridge node is a nominal server, and the system creates a packet tunneling protocol to connect the client anonymously to an external resource.

### EMBODIMENT 2

The hybrid or hive anonymity system as in embodiment 1, wherein a user connects to the Bridge node via an internet capable device.

### EMBODIMENT 3

The hybrid or hive anonymity system as in embodiments 1 or 2, wherein the system creates a packet tunneling protocol to connect a user anonymously to an external resource.

### EMBODIMENT 4

The hive anonymity system as in any of the foregoing embodiments, wherein a tunnel is established between the Stem node and the Leaf node sharing an inter process communication link with the Branch node.

### EMBODIMENT 5

A Hybrid Wide Area Network Inter Process Communication system using a doubly linked list, the system comprising: forming a core comprising a Branch Node and a Stem Node; receiving a request from a client; creating a socket connection to the Branch Node; creating a thread and link in the doubly linked list by the Branch Node; connecting the Stem Node and the Branch Node by an internal IPC; searching the list by the Stem Node, wherein the Stem Node uses an SLT over an IPC in cooperation with the Branch Node to find an available job and returns the job to the Leaf Node; attaching a thread/process to a pointer of an IPC memory segment holding the link in the list; and establishing a memory pipe between the Client, the Branch Node, the Stem Node, and the Leaf Node.

### EMBODIMENT 6

The Hybrid Wide Area Network Inter Process Communication system as in embodiment 5, further comprising: when the Leaf Node returns data, writing to a socket that is connected to the Stem Node.

### EMBODIMENT 7

The Hybrid Wide Area Network Inter Process Communication system as in embodiments 5 or 6, further comprising: reading the payload by the Stem node and writing to the IPC memory segment that contains a socket directly connected to the Client.

### EMBODIMENT 8

The Hybrid Wide Area Network Inter Process Communication system as in embodiments 5, 6 or 7, further comprising: responding by the Client over the socket that is connected to the Branch Node.

### EMBODIMENT 9

The Hybrid Wide Area Network Inter Process Communication system as in embodiments 5 through 8, further comprising: writing, by the Branch Node, to the IPC with the Stem Node that contains a socket connected to the Leaf Node.

### EMBODIMENT 10

The Hybrid Wide Area Network Inter Process Communication system as in embodiments 5 through 9, further comprising: reading, by the Leaf Node, a response until connection is terminated.

### EMBODIMENT 11

A Simi-Lockless Triplet, comprising: locking only a minimum number of links in a doubly linked list.

### EMBODIMENT 12

The Simi-Lockless Triplet as in embodiment 11, further comprising: adding an item at a head of the list by proving each required link with a locking request and acquiring a lock thereon; pushing a second link into a memory structure of the list by pointing to an address of a third link; updating a pointer of the second link to the initial link in the list; and updating the initial link with the address of the second link.

### EMBODIMENT 13

The Simi-Lockless Triplet as in embodiment 12, wherein reversing order to add an item at the end of the list.

### EMBODIMENT 14

The Simi-Lockless Triplet as in embodiments 12 or 13, wherein an item is removed from any point except the beginning or end by proving each required link with a locking request; acquiring a first removal link to be removed; acquired a lock on a second link prior to the first removal link; acquiring a lock on a third link following the first removal link; updating a pointer of the first removal link no longer point to the third link; updating the third link pointer to the first removal link; releasing locks on the third link pointer and the first removal link; and deleting the second link.

### EMBODIMENT 15

An artificial intelligent system comprising a neural network trained to route a user request from an r2b server to a resource via a plurality of external IP addresses, wherein the request is fragmented into a plurality of sub-requests as perceived by the resource, each sub-request receiving a discrete pipe for sending and receiving data to and from the user.

### EMBODIMENT 16

The artificial intelligent system as in embodiment 15, wherein the data is returned to the user via another set of IP addresses.

### EMBODIMENT 17

A hive anonymity system, comprising a branch node being in communication with a client or to a load balancer, a stem node in communication with the branch node, and a leaf node in communication with the stem node, wherein a packet tunneling protocol is established by the nodes to connect the client anonymously to an external resource.

### EMBODIMENT 18

The hive anonymity system as in embodiment 17, further comprising: a bridge node acting as a nominal server for the client.

### EMBODIMENT 19

A hive anonymity system, comprising a branch node being in communication with a client or to a load balancer, a stem node in communication with the branch node, a leaf node in communication with the stem node, and a bridge node acting as a nominal server for the client to connect the client anonymously to an external resource.

### EMBODIMENT 20

The hive anonymity system as in embodiment 19, wherein the bridge node creates a packet tunneling protocol to connect the client to the external resource.

That which is claimed is:

1. A hive anonymity system, comprising:
a branch node being in communication with a client or to a load balancer,
a stem node in communication with the branch node,
a leaf node in communication with the stem node, and
a bridge node acting as a nominal server for the client, wherein the system creates a packet tunneling protocol to connect the client anonymously to an external resource.

2. The hive anonymity system as in claim 1, wherein the stem node is a point to which the leaf node connects.

3. The hive anonymity system as in claim 1, wherein the leaf node is a random, geographically distributed affiliate point being configured to request a payload to process from the bridge node.

4. The hive anonymity system as in claim 1, wherein the client connects to the bridge node via an internet capable device.

5. The hive anonymity system as in claim 1, wherein a tunnel is established between the stem node and the leaf node sharing an inter process communication link with the branch node.

6. A method of establishing and using a Hybrid Wide Area Network Inter Process Communication system using a doubly linked list, the method comprising:
forming a core comprising a branch node and a stem node;
receiving a request from a client;
creating a socket connection to the branch node;
creating a thread and link in the doubly linked list by the branch node;
connecting the stem node and the branch node by an inter process communicator;
searching the list by the stem node, wherein the stem node uses a simi-lockless triplet over the inter process communicator in cooperation with the branch node to find an available job and returns the job to the leaf node;
attaching a thread to a pointer of an inter process communicator memory segment holding the link in the list; and
establishing a memory pipe between the client, the branch node, the stem node, and the leaf node.

7. The method as in claim 6, further comprising: when the leaf node returns data, writing to a socket that is connected to the stem node.

8. The method as in claim 6, further comprising: reading the payload by the stem node and writing to the inter process communicator memory segment that contains a socket connected to the client.

9. The method as in claim 6, further comprising: sending a response from the client over the socket that is connected to the branch node.

10. The method as in claim 6, further comprising: writing, by the branch node, to the inter process communicator with the stem node that contains a socket connected to the leaf node.

11. The method as in claim 6, further comprising: reading, by the leaf node, a response until connection is terminated.

12. A method of establishing and using a simi-lockless triplet, comprising:
locking only a minimum number of links in a doubly linked list;
adding an item at a head of the list by proving each required link with a locking request and acquiring a lock thereon;
pushing a second link into a memory structure of the list by pointing to an address of a third link;
updating a pointer of the second link to the initial link in the list; and
updating the initial link with the address of the second link.

13. The method as in claim 12, further comprising: reversing order to add an item at the end of the list.

14. The method as in claim 12, further comprising:
removing an item from any point except the beginning or end by proving each required link with a locking request;
acquiring a first removal link to be removed;
acquiring a lock on a second link prior to the first removal link;
acquiring a lock on a third link following the first removal link;
updating a pointer of the first removal link to no longer point to the third link;
updating the third link pointer to the first removal link;
releasing locks on the third link pointer and the first removal link; and deleting the second link.

15. The method as in claim 12, wherein the doubly linked list is associated with an inter process communicator.

16. An artificial intelligent system for connect a client anonymously to an external resource, the system comprising:
a neural network trained to route a user request from an r2b server to a resource via a plurality of external IP addresses, wherein the request is fragmented into a plurality of sub-requests as perceived by the resource, each sub-request receives a discrete pipe for sending and receiving data to and from w user.

17. The artificial intelligent system as in claim 16, wherein the data is returned to the user via another set of IP addresses.

18. A hive anonymity system, comprising:
a branch node being in communication with a client or to a load balancer,
a stem node in communication with the branch node, and
a leaf node in communication with the stem node, wherein a packet tunneling protocol is established by the nodes to connect the client anonymously to an external resource.

19. The hive anonymity system as in claim 18, further comprising:
a bridge node acting as a nominal server for the client.

20. A hive anonymity system, comprising:
a branch node being in communication with a client or to a load balancer,
a stem node in communication with the branch node,
a leaf node in communication with the stem node, and
a bridge node acting as a nominal server for the client to connect the client anonymously to an external resource.

21. The hive anonymity system as in claim 20, wherein the bridge node creates a packet tunneling protocol to connect the client to the external resource.
